(19) United States
(12) Patent Application Publication
(10) Pub. No.: US 2006/0078240 A1
(43) Pub. Date: Apr. 13, 2006

(54) Fluid dynamic bearing system to rotatably support a spindle motor

(76) Inventor: Dieter Braun, Spaichingen (DE)

Correspondence Address: NORMAN H. ZIVIN;Cooper & Dunham LLP, 1185 Avenue of the Americas, New York, NY, 10036, US

(21) Appl. No.: 11/242,471

(22) Filed: Oct. 3, 2005

(30) Foreign Application Priority Data
Oct. 8, 2004 (DE) 10 2004 049 077.5

(51) Int. Cl. F16C 32/06

(52) U.S. Cl. 384/107

(57) ABSTRACT

The invention relates to a fluid dynamic bearing system for the particular purpose of rotatably supporting a spindle motor used to drive the disk(s) of a hard disk drive having a stationary shaft, a thrust plate connected to the shaft, a bearing sleeve rotatable about the rotational axis of the shaft and a cover sealing the bearing sleeve, wherein the surfaces of the shaft, the thrust plate, the bearing sleeve and the cover, that face each other and are separated from each other by a fluid-filled bearing gap, form at least one radial bearing region and at least one axial bearing region. According to the invention, the shaft is designed as a hollow shaft, and the cover has a cylindrical section concentric to the rotational axis that is rotatably accommodated in the hollow shaft in such a way that between the inside diameter of the hollow shaft and the outside diameter of the cylindrical section of the cover, an inner bearing gap filled with bearing fluid is formed, the inner bearing gap being connected to the outer bearing gap.

### BACKGROUND OF THE INVENTION

The invention relates to a fluid dynamic bearing system for the particular purpose of rotatably supporting a spindle motor used, for example, to drive the disk(s) of a hard disk drive according to the preamble of claim 1.

### PRIOR ART

Spindle motors essentially consist of a stator, a rotor and at least one bearing system arranged between these two parts. The electrically driven rotor is rotatably supported with respect to the stator by means of the bearing system. Included among the kinds of bearings used in bearing systems are roller bearings and fluid or fluid dynamic bearing systems.

A well-known embodiment of a fluid dynamic bearing system, revealed, for example, in DE 201 19 716 U1, comprises a stationary shaft and a bearing sleeve that has an axial bore to receive the shaft. The sleeve rotates freely about the stationary shaft and forms a radial bearing together with the shaft. The mutually interacting bearing surfaces of the shaft and sleeve are spaced apart from each other by a thin, concentric, lubricant-filled bearing gap. A surface pattern is formed on at least one of the bearing surfaces which, due to the relative rotary movement between the sleeve and the shaft, exerts local accelerating forces on the lubricant located in the bearing gap. A kind of pumping action is generated in this way resulting in the formation of a homogeneous lubricating film of regular thickness within the bearing gap which is stabilized by means of fluid dynamic pressure zones. The bearing sleeve carries a rotor hub on which, for example, the disks of a hard disk drive are disposed.

Displacement of the above-described arrangement along the rotational axis is prevented by at least one appropriately designed fluid dynamic axial bearing. In a fluid dynamic axial bearing, the bearing surfaces mutually interacting with each other, of which at least one is provided with a surface structure, are each arranged on a plane perpendicular to the rotational axis and are spaced axially apart from each other by a thin, preferably even, lubricant-filled bearing gap. The fluid dynamic thrust bearings provided to take on axial loads are preferably formed by the two end faces of a thrust plate arranged at the end of the shaft, one of the end faces of the thrust plate being associated with a corresponding end face of the sleeve and the other end face being associated with the inside end face of a cover. The cover thus forms a counter bearing to the thrust plate and seals the open end of the bearing system, preventing air from penetrating into the bearing gap filled with lubricant.

Other embodiments of fluid dynamic bearings are known, for example from U.S. Pat. No. 6,183,135 B1, that have a stationary bearing sleeve and a shaft rotating within the bore in the sleeve.

In the bearing systems mentioned above, the cover that forms the counter bearing for the thrust plate consists of a flat disk. In spindle motors having stationary shafts, as employed in hard disk drives, it is not possible to use a central fastening screw (clamping screw), as required, for example, to fix the. disk(s) onto the rotor hub, since the cover is not thick enough to receive a screw of the appropriate size. This means that the overall height of such motors is increased in comparison to motors having rotating shafts.

### SUMMARY OF THE INVENTION

The object of the invention is to improve a fluid dynamic bearing system for spindle motors in such a way that the use of a central fastening screw in conjunction with a stationary shaft is made possible. Furthermore, the proposed bearing system is meant to achieve high bearing stiffness and rotational stability.

This object has been achieved according to the invention by the characteristics outlined in claim 1.

Further preferred and beneficial embodiments of the invention are cited in the subordinate claims.

In the bearing system according to the invention, the shaft is designed as a hollow shaft. The cover has a cylindrical section concentric to the rotational axis that is rotatably accommodated in the hollow shaft in such a way that an inner bearing gap filled with bearing fluid is formed between the inside diameter of the hollow shaft and the outside diameter of the cylindrical section of the cover, the bearing gap being connected to the outer bearing gap. The design of the shaft and cover as described above makes it possible to provide a central thread in the cover to receive a fastening screw, a substantial part of the thread running within the cylindrical shoulder.

In accordance with a preferred embodiment of the invention, provision is made for the cover to be accommodated in a recess in the bearing sleeve so that the bearing sleeve and the cover substantially form one plane. In a preferred embodiment of the invention, the bearing sleeve directly forms the rotor hub of the spindle motor, i.e. the bearing sleeve is an integral part of the rotor hub.

The thrust plate is likewise accommodated in an annular recess in the bearing sleeve and covered by the cover. The thrust plate is preferably formed integrally with the hollow shaft; however, it can also be formed as a separate part firmly fixed to the hollow shaft.

According to the invention, the cover with its cylindrical section—together with appropriate parts of the shaft and the thrust plate—can be formed as a functional part of the fluid dynamic bearing system. For this purpose, regions on the inside surface of the hollow shaft and/or regions on the outside surface of the cylindrical section of the cover are provided with surface patterns and thus form an additional radial bearing region. The surfaces facing each other of the thrust plate and the cover or the thrust plate and the bearing sleeve respectively preferably form a double axial bearing. This embodiment of the invention goes to beneficially increase the stability and stiffness of the bearing.

What is more, the design and construction as described above, results in a lower overall height and, due to the low-friction fluid dynamic bearing, a low operating current for the spindle motor.

To improve the circulation of the bearing fluid between the inner and the outer bearing gap, according to the invention the hollow shaft can have at least one hole or opening which, for example, is disposed between the two outer radial bearing regions and connects the inner bearing gap to the outer bearing gap. This hole forms a recirculation channel for the bearing fluid from the inner bearing gap to the outer bearing gap, in other words from the inner bearing regions to the outer bearing regions. The opening can basically be provided at any point along the shaft that allows the inner and outer bearing gaps to be connected.

The open lower end of the hollow shaft is closed by a plug so that no bearing fluid can escape from the bearing and no dirt can penetrate into the bearing. The plug can have a step, a groove or a hole, so that in the region of this step/groove/hole between the inside diameter of the shaft and the outside diameter of the plug, a channel is formed that is connected to the inner bearing gap. Together with a suitably disposed hole in the hollow shaft, this channel provides a direct connection between the inner axial bearing region or the radial bearing region and the outer, lower radial bearing region. The plug can be connected to the hollow shaft by means, for example, of pressing, bonding or welding.

A seal (called a visco-seal) formed as an annular groove in the bearing sleeve or in the hollow shaft is preferably provided in the region of the open end of the outer bearing gap in order to seal the outer bearing gap. This groove can be tapered, widening towards the open end of the outer bearing gap, for instance, or be formed as a straight seal having a very small aperture angle. It goes, of course, without saying that other known sealing methods such as labyrinth seals, magnetic fluid seals or suchlike can also be provided.

### BRIEF DESCRIPTION OF THE DRAWINGS

An embodiment of the invention is described in more detail below on the basis of the drawings. Further characteristics, advantages and applications of the invention can be derived from the drawings and their description. The drawings show:

FIG. 1: a schematic sectional view of a spindle motor having a bearing system designed according to the invention;

FIG. 2: a view of the hollow shaft with engraved surface patterns;

FIG. 3: a view of the cover with engraved surface patterns.

### DESCRIPTION OF A PREFERRED EMBODIMENT OF THE INVENTION

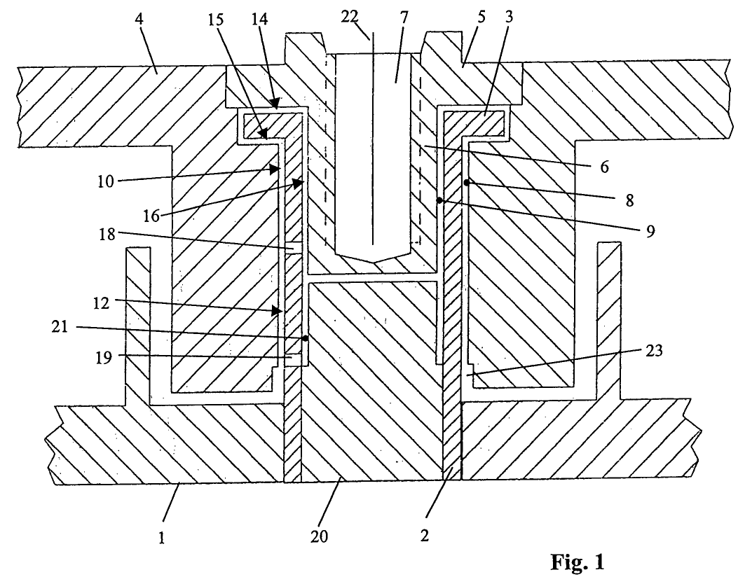

FIG. 1 shows a schematic sectional view of a spindle motor to drive a hard disk drive having a fluid dynamic bearing system according to the invention. The electromagnetic components needed to operate the spindle motor, such as stator windings, permanent magnets, etc. are not illustrated in the drawing.

The spindle motor comprises a stationary baseplate 1. A hollow shaft 2 is arranged in an opening in the baseplate 1 and firmly fixed to the baseplate. At its free end, the hollow shaft 2 comprises an annular flange which forms a thrust plate 3 as part of an axial bearing as described below. The shaft 2 and thrust plate 3 may be formed integrally and are enclosed by a bearing sleeve 4 that has an axial cylindrical bore to receive the shaft 2. The thrust plate 3 is accommodated in a larger diameter annular recess in the bearing sleeve. The inside diameter of the bore or recess in the bearing sleeve 4 is slightly larger than the outside diameter of the shaft or the outside diameter of the thrust plate 3, so that a bearing gap 8 is formed between the shaft 2, thrust plate 3 and bearing sleeve 4. The thrust plate 3 or the upper region of the bearing sleeve 4 is covered by a cover 5 that has a cylindrical section 6 which projects into the interior of the hollow shaft 2. The outside diameter of the cylindrical section 6 is slightly smaller than the inside diameter of the hollow shaft 2. As a result, an inner bearing gap 9 is produced between the surfaces of the cover 5 or its cylindrical section 6 respectively and the shaft 2. The bearing sleeve 4 preferably takes the form of a rotor hub which carries one or more disks (not illustrated) of a hard disk drive. The cover 5 comprises a central threaded bore 7 that projects into the cylindrical section 6 and is used to receive a fastening screw by means of which, for example, disks of the hard disk drive are connected to the bearing sleeve 4.

It can be seen that the outer bearing gap 8 is connected to the inner bearing gap 9 via the section of the gap surrounding the thrust plate 3. Both bearing gaps 8, 9 are filled with a bearing fluid, preferably a bearing oil. To prevent bearing fluid from escaping from the bearing gap 8 or dirt from penetrating into the bearing gap 8, in the region of the open end of the bearing gap 8, an annular groove 23, which acts as a seal (called a “visco-seal”), is provided in the bearing bush 4. Although not illustrated here, this groove can be tapered, widening towards the open end of the bearing gap or it can be formed as a “straight seal” having a very small aperture angle.

The actual fluid dynamic bearing system is formed on the one hand by two radial bearing regions 10, 12 that are marked by surface patterns which are provided on the outside surface of the hollow shaft 2 and/or on the inside surface of the bearing sleeve 4 located opposite the hollow shaft 2.

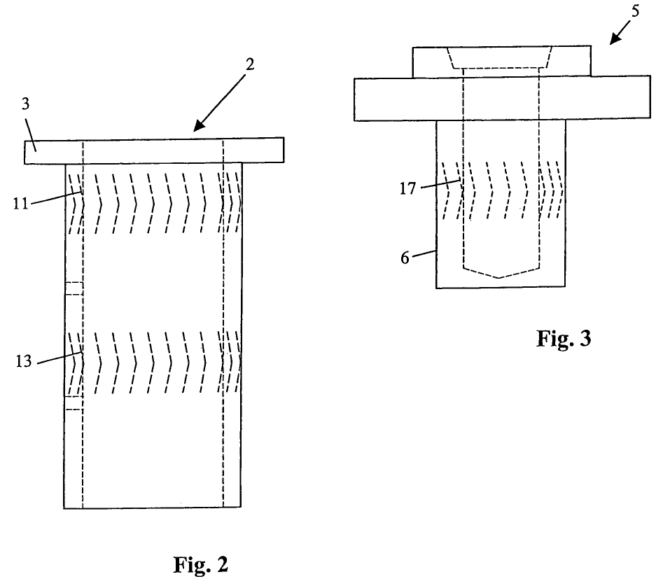

A view of the hollow shaft 2 is shown in FIG. 2 which has surface patterns 11, 13 for example, on its outside circumference, the surface patterns defining the above-mentioned radial bearing region. These surface patterns could, of course, also be disposed on the respective opposing surface of the bearing sleeve 4. As soon as the moveable bearing sleeve 4 is set in rotation, fluid dynamic pressure is built up in the bearing gap 8 due to the surface patterns 11, 13, so that the radial bearing 10, 12 attains its load bearing capacity.

In the region of the free end of the shaft 2, the bearing sleeve 4 is sealed by the specially designed cover 5, which is preferably disposed in an annular recess in the bearing sleeve 4. The cover 5 has a cylindrical section 6 concentric to the rotational axis 22 that is rotatably accommodated in the shaft 2 in such a way that the inner bearing gap 9 is formed between the inside surfaces of the hollow shaft 2 and the outside surfaces of the cylindrical section 6. During rotation of the spindle motor, the cover 5 rotates together with the shoulder 6 within the hollow shaft 2. The end faces of the thrust plate 3, i.e. the surfaces running perpendicular to the rotational axis 22, together with the corresponding opposing end faces of the cover 5 or of the bearing sleeve 4 respectively, form the axial bearing regions 14, 15 (fluid dynamic thrust bearings). Parts of the surfaces of the axial bearing regions 14, 15 are similarly provided with appropriate surface patterns that exert a pumping action on the bearing fluid. The shape and design of the surface patterns is known to a person skilled in the art and thus not further illustrated in the drawings.

The inside surface of the hollow shaft 2 and the outside surface of the cylindrical shoulder 6 can also form an additional radial bearing region 16.

A view of the cover 5 together with the cylindrical shoulder 6 is shown in FIG. 3, surface patterns 17 that define the above-described radial bearing region being formed on the outside circumference of the cylindrical section 6. These surface patterns 17 could of course be disposed on the inside surface of the hollow shaft 2 accordingly.

To enable the bearing fluid to circulate within the bearing gaps 8, 9, the hollow shaft 2 can have a transversal hole 18 that forms an additional means of connection between the two bearing gaps 8, 9. The lower end of the shaft 2 is closed by a plug 20 that is fixedly accommodated in the shaft 2 and does not come into contact with the end face of cylindrical section 6 of the cover 5. Between the end face of the cylindrical section and the plug 20, there remains a space that defines the closed end of the inner bearing gap 9. The plug 20 can have a step, a groove or a hole on its outside diameter so that a channel 21 is formed between the outside diameter thus reduced and the inside diameter of the hollow shaft 2. This channel 21 represents a downward continuation of the inner bearing gap 9 and can lead into a hole 19 in the hollow shaft 2 that connects this channel 21 to the outer bearing gap 8. The channel 21 consequently acts as another recirculation channel for the bearing fluid between the inner and the outer bearing gap 8 or 9.

Instead of having a plug 20, the shaft 2 can also be made of solid material in this region, i.e. the shaft is only hollow in its upper region.

The openings 18, 19 in the hollow shaft 2 can generally be provided at any points along the shaft 2 that allow the two bearing gaps 8, 9 to be connected to each other.

### IDENTIFICATION REFERENCE LIST

1 Baseplate

2 Hollow shaft

3 Thrust plate

4 Rotor/bearing sleeve

5 Cover

6 Cylindrical section

7 Threaded bore

8 Bearing gap (outer)

9 Bearing gap (inner)

10 Radial bearing region

11 Surface pattern

12 Radial bearing region

13 Surface pattern

14 Axial bearing region

15 Axial bearing region

16 Radial bearing region

17 Surface pattern

18 Hole

19 Hole

20 Plug

21 Channel

22 Rotational axis

23 Groove (seal)

1. A fluid dynamic bearing system for the particular purpose of rotatably supporting a spindle motor used to drive the disk(s) of a hard disk drive having a stationary shaft (2), a thrust plate (3) connected to the shaft, a bearing sleeve (4) rotatable about the rotational axis (22) of the shaft and a cover (5) sealing the bearing sleeve, wherein the surfaces of the shaft, the thrust plate, the bearing sleeve and the cover, that face each other and are separated from each other by a fluid-filled bearing gap (8), form at least one radial bearing region (10; 12) and at least one axial bearing region (14; 15),
characterized in that
the shaft (2) is designed as a hollow shaft, and
that the cover (5) has a cylindrical section (6) concentric to the rotational axis (22) which is rotatably accommodated in the hollow shaft in such a way that between the inside diameter of the hollow shaft and the outside diameter of the cylindrical section of the cover, an inner bearing gap (9) filled with bearing fluid is formed, the inner bearing gap being connected to the outer bearing gap (8).

2. A fluid dynamic bearing system according to claim 1, characterized in that the bearing sleeve (4) has an annular recess to receive the cover (5).

3. A fluid dynamic bearing system according to claim 1, characterized in that the bearing sleeve (4) has an annular recess to receive the thrust plate (3).

4. A fluid dynamic bearing system according to claim 1, characterized in that the cover (5) has a central threaded bore (7) to receive a fastening screw.

5. A fluid dynamic bearing system according to claim 1, characterized in that the surfaces of the hollow shaft (2) and of the cylindrical section (6) of the cover separated from each other by the inner bearing gap (9) form an additional radial bearing region (16).

6. A fluid dynamic bearing system according to claim 5, characterized in that the radial bearing regions (10; 12; 16) and the axial bearing regions (14; 15) are defined by surface patterns (11; 13; 17) formed on at least one of paired bearing surfaces.

7. A fluid dynamic bearing system according to claim 1, characterized in that the hollow shaft (2) has at least one hole (18; 19) that connects the inner bearing gap (9) to the outer bearing gap (8).

8. A fluid dynamic bearing system according to claim 1, characterized in that one end of the hollow shaft (2) is sealed by means of a plug (20).

9. A fluid dynamic bearing system according to claim 8, characterized in that the plug (20) has a step, a groove or a hole such that a channel (21) which is connected to the inner bearing gap (9) is defined between the outside diameter of the plug and the inside diameter of the hollow shaft or within the plug.

10. A fluid dynamic bearing system according to claim 9, characterized in that the channel (21) is connected via the hole (19) to the outer bearing gap (8).

11. A fluid dynamic bearing system according to claim 1, characterized in that in the region of the open end of the outer bearing gap (8) a seal formed as an annular groove (23) is provided in the bearing sleeve (4) or in the hollow shaft (2).
